(19) United States
(12) Patent Application Publication
(10) Pub. No.: US 2022/0334788 A1
(43) Pub. Date: Oct. 20, 2022

(54) ELECTRONIC APPARATUS AND CONTROL METHOD THEREOF

(71) Applicant: SAMSUNG ELECTRONICS CO., LTD., Suwon-si (TW)

(72) Inventor: Hojeen JEE, Suwon-si (KR)

(21) Appl. No.: 17/856,580

(22) Filed: Jul. 1, 2022

Related U.S. Application Data
(63) Continuation of application No. PCT/KR2020/019298, filed on Dec. 29, 2020.

(30) Foreign Application Priority Data
Jan. 2, 2020 (KR) 10-2020-0000334

(51) Int. Cl. G06F 3/14; G06F 3/147; H04N 21/436

(52) U.S. Cl. CPC G06F 3/1407; G06F 3/147; H04N 21/43615

(57) ABSTRACT

An electronic apparatus includes: a display; at least one of interface part comprising interface circuitry; and a processor configured to: receive data of a content including a plurality of image frames from an external apparatus through the interface part and process the image frames to display the plurality of image frames on the display based on the received data of the content, wherein the processor is further configured to: identify a play time of the image frame based on information obtained from the received data of the content, identify a form in which an input for the content is received, and adjust the identified play time of the image frame based on the identified form in which the input for the content is received.

### CROSS-REFERENCE TO RELATED APPLICATIONS

This application is a continuation of International Application No. PCT/KR2020/019298 designating the United States, filed on Dec. 29, 2020, in the Korean Intellectual Property Receiving Office and claiming priority to Korean Patent Application No. 10-2020-0000334, filed on Jan. 2, 2020, in the Korean Intellectual Property Office, the disclosures of which are incorporated by reference herein in their entireties.

### BACKGROUND

### Field

The disclosure relates to an electronic apparatus and a control method thereof which perform a role of a sink device to receive data of a content from a source device and display an image of the content, for example, to an electronic apparatus and a control method thereof which is capable of adjusting display time of a mirroring image that is displayed based on the received data from the source device.

### Description of Related Art

An electronic apparatus, which basically includes electronic devices such as a central processing unit, a chipset, a memory, etc. in order to compute and process information according to a process, may be categorized into various types according to what the information to be processed or the usage of the electronic apparatus is. For example, as the electronic apparatus, there are an information processing apparatus of general purpose for processing information such as a personal computer, a server, etc., an image processing apparatus for processing image data, an audio apparatus for processing audio, home appliances for performing household chores, and the like. The image processing apparatus may be embodied as a display apparatus which displays image data processed as an image on a display panel provided therein.

The display apparatus receives data of a content from an external apparatus which is connected to communicate therewith and processes the received data to display the image. The characteristic of the image displayed by the display apparatus may be varied according to the characteristic of the data provided by the external apparatus. For example, while the external apparatus displays a first image of the content processed, the external apparatus may transmit to the display apparatus data which is buffered to display the first image. The display apparatus displays a second image based on the data which is received from the external apparatus. In this case, the second image which is displayed by the display apparatus is a mirroring image of the first image which is displayed by the external apparatus. Accordingly, mirroring represents a function where an image which is displayed by one display apparatus is displayed by another display apparatus in the same manner.

The display apparatus and the external apparatus may be connected with each other through a wired or wireless method according to various reasons such as convenience. While the external apparatus encodes data according to a wireless transmission standard and transmits the data to the display apparatus, the display apparatus receives and decodes the data according to the same wireless transmission standard as that of the external apparatus. Here, the display apparatus includes a buffer or queue for buffering the received data. The buffer provided in the display apparatus receiving the data may refer, for example, to the following. The wireless communication environment between the display apparatus and the external apparatus may vary due to various reasons such as noise, interference by communication of another electronic apparatus, etc. Accordingly, the transmission rate of the data which is transmitted from the external apparatus to the display apparatus is not guaranteed to be uniform. Therefore, the display apparatus buffers the received data in the buffer so as to display an image without halting.

### SUMMARY

According to an example embodiment of the disclosure, an electronic apparatus includes: a display; at least one interface; and a processor configured to: receive data of a content which includes a plurality of image frames from an external apparatus through the interface and process to display the plurality of image frames on the display based on the received data of the content, wherein the processor is further configured to: identify a play time of the image frame based on information obtained from the received data of the content, identify a form in which an input for the content is received, and adjust the identified play time of the image frame based on the identified form in which the input for the content is received.

Further, the form in which the input is received may include a frequency of the input for the content.

Further, the processor may adjust the play time based on a predefined (e.g., specified) delay time.

Further, the processor may identify the delay time based on communication environment in which the data of the content is transmitted from the external apparatus.

Further, the processor may identify the delay time based on a time which is taken from when the data of the content including the image frame is received at the interface part to when the image frame is displayed on the display.

Further, the processor may increase or decrease the delay time based on the form in which the input is received.

Further, the processor may identify the form in which the input is received based on a type of the content.

Further, the processor may decrease the delay time based on the input for the content being identified to be present at the external apparatus.

Further, the processor may identify whether the input is present based on a result of a scene analysis on the frame.

Further, the processor may identify whether the input is present based on a signal which is related with the input received from the external apparatus through the interface part.

Further, the processor may identify whether the input is present based on a signal related with the input received through the interface from a server which communicates with the external apparatus.

Further, the processor may perform decoding of the data and perform rendering of the data on which the decoding has been performed based on the adjusted play time.

According to an example embodiment of the disclosure, a method of controlling an electronic apparatus, includes: receiving data of a content which includes a plurality of image frames from an external apparatus; identifying a play time of the image frame based on information obtained from the received data of the content; identifying a form in which an input for the content is received; adjusting the identified play time of the image frame based on the identified form in which the input is received; and displaying the image frame based on the adjusted play time.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example sink device which displays a mirroring image of an image that is displayed by a source device according to various embodiments;

FIG. 2 is a block diagram illustrating an example configuration of the sink device according to various embodiments;

FIG. 3 is a flowchart illustrating an example operation of the sink device according to various embodiments;

FIG. 4 is a block diagram illustrating elements of the sink device for each role related to the processor of the sink device according to various embodiments;

FIG. 5 is a flowchart illustrating an example process in which the sink device adjusts the delay time regarding the play time of the image according to various embodiments;

FIG. 6 is a diagram illustrating an example in which the user input is conducted at the source device or the sink device according to various embodiments;

FIG. 7 is a diagram illustrating various example routes through which the sink device obtains the information which is referred to in order to identify the form in which the user input for the content is received according to various embodiments;

FIG. 8 is a diagram illustrating an example method in which the sink device adjusts the display time of each of a plurality of the image frames if a frequency that the user input for the content is received is relatively high according to various embodiments; and

FIG. 9 is a diagram illustrating an example method in which the sink device adjusts the display time of each of a plurality of the image frames if a frequency that the user input for the content is received is relatively low according to various embodiments.

### DETAILED DESCRIPTION

Below, various example embodiments of the disclosure will be described in greater detail with reference to the accompanying drawings. In the drawings, like numerals or symbols refer to like elements having substantially the same function, and the size of each element may be exaggerated for clarity and convenience of description. However, the technical concept of the disclosure and its key configurations and functions are not limited to those described in the following example embodiments. In the following descriptions, details about publicly known technologies or configurations may be omitted if they unnecessarily obscure the gist of the disclosure.

In the following embodiments, terms ‘first’, ‘second’, etc. are used simply to distinguish one element from another, and singular forms are intended to include plural forms unless otherwise mentioned contextually.

In the disclosure, a term “at least one of” a plurality of elements or the like may not refer to all of the plurality of elements but also to each and every possible combination of the elements.

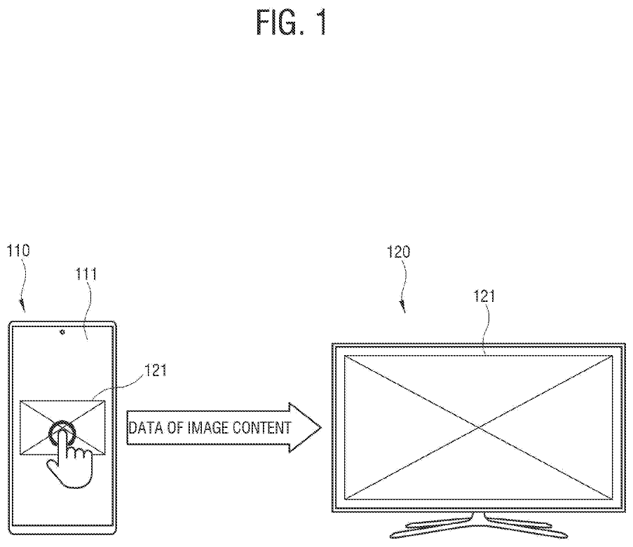

FIG. 1 is a diagram illustrating an example sink device which displays a mirroring image of an image that is displayed by a source device according to various embodiments.

As illustrated in FIG. 1, a plurality of electronic apparatuses 110 and 120 is provided to be able to wirelessly communicate with each other and is embodied as a display apparatus which can display an image. In order to distinguish between the two electronic apparatuses 110 and 120 of the disclosure, the electronic apparatuses 110 and 120 are referred to, according to a role thereof, as a source device 110 which provides a content and a sink device 120 which is provided with the content, respectively. Because such terms are simply for differentiation to each other, various terms may be applied other than the source device 110 and the sink device 120. For example, the source device 110 and the sink device 120 may be referred to, for convenience, as a first electronic apparatus and a second electronic apparatus, a first display apparatus and a second display apparatus, an external apparatus and an electronic apparatus, etc., respectively.

The disclosure illustrates, by way of non-limiting example, a case that the sink device 120 and the source device 110 are embodied as a television and a mobile device, respectively. However, various design changes may be applied regarding which type of devices each of the electronic apparatuses 110 and 120 is embodied as, and an example of the disclosure does not limit an embodiment type of the electronic apparatuses 110 and 120. The sink device 120 or the source device 110 may be embodied as various types of devices, for example, a stationary display apparatus including a television, a monitor, a digital signage, an electronic board, an electronic picture frame, etc., an image processing apparatus including a set-top box, an optical media player, etc., an information processing apparatus including a computer, etc., a mobile device including a smart phone, a tablet, etc., a wearable device and the like.

The source device 110 and the sink device 120 perform a wireless communication according to a predefined wireless communication standard. The wireless communication standard may be a method through a relay apparatus such as an access point or a one-to-one direct method between the source device 110 and the sink device 120. For example, as the wireless communication standard, Wi-Fi, Wi-Fi Direct, Bluetooth, Bluetooth Low Energy, Wireless high-definition multimedia interface (HDMI), etc. may be applied.

The source device 110 processes content data and displays a first image 111. An event related to displaying of a second image 121 may occur at the source device 110 or the sink device 120, while the first image 111 is displayed at the source device. In response to the event, the source device 110 transmits the content data of the first image 111 to the sink device 120 through the wireless communication described above. The sink device 120 processes the data which is received from the source device 110 and displays the second image 121.

The second image 121 may be a mirroring image of the first image 111. In this case, because the source device 110 delivers the data on which image processing is performed to display the first image 111 to both a display of the source device 110 and the sink device 120, the second image 121 depends upon a state change of the first image 111. For example, when a display state of the first image 111 at the source device 110 is adjusted according to a user input, etc., the adjusted display state is applied to the second image 121 in a same manner.

Here, because wireless communication environment between the source device 110 and the sink device 120 may change according to various causes, a transmission rate of the data which is transmitted from the source device 110 to the sink device 120 may also not be uniform. The transmitted data includes image data having a plurality of image frames and information on a predefined play time to display each of the image frames. When the data is received, the sink device 120 delays the play time of each image frame of the data to be later than a predefined content play time and displays the second image 121. The operation of the sink device 120 delaying the play time of the image frame will be described in detail below.

Hereafter, various configurations of the sink device 120 will be described in greater detail.

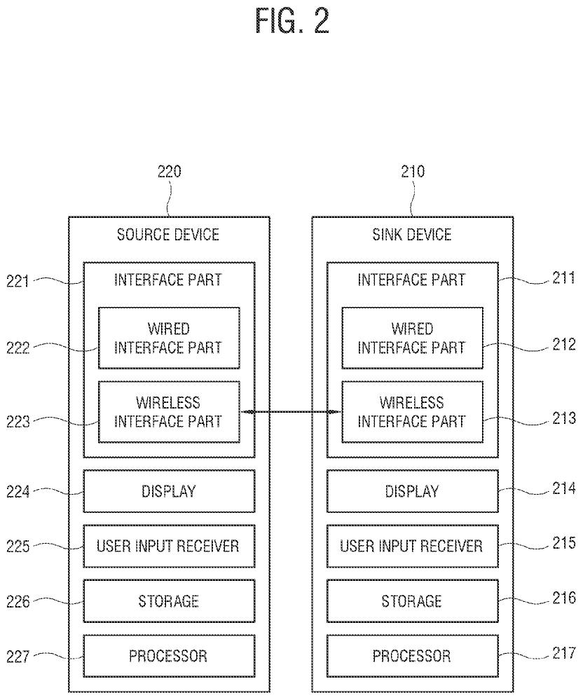

FIG. 2 is a block diagram illustrating example configurations of the sink device according to various embodiments.

As illustrated in FIG. 2, a sink device 210 includes many hardware elements needed for operations. The elements included in the sink device 210 are not limited to only the examples of the disclosure, but may include additional elements or exclude some elements as necessary when the sink device 210 is embodied.

The sink device 210 may include an interface part (e.g., an interface) 211. The interface part 211 includes interface circuitry through which the sink device 210 performs communication with various kinds of external apparatuses, such as the source device 220, and a server and transmits and receives data.

The interface part 211 may include one or more wired interface part 212 for wired communication. The wired interface part 212 includes a connector or port to which a cable of a predefined transmission standard is connected. For example, the wired interface part 212 includes a port to connect with a terrestrial or satellite antenna to receive a broadcast signal or connect with a cable for cable broadcasting. Further, the wired interface part 212 includes ports to which cables of various wired transmission standards such as high definition multimedia interface (HDMI), DisplayPort (DP), digital video interactive (DVI), component, composite, S-video, thunderbolt, and the like to connect with various image processing apparatuses. Further, the wired interface part 212 includes a port of a universal serial bus (USB) standard to connect with a USB device. Further, the wired interface part 212 includes an optical port to which an optical cable is connected. Further, the wired interface part 212 includes an audio input port to which an external microphone is connected, and an audio output port to which a headset, an earphone, an external speaker, etc. is connected. Further, the wired interface part 212 includes an Ethernet port to connect with a gateway, a router, a hub, etc. for connection with a wide area network.

The interface part 211 may include one or more wireless interface part 213 for wireless communication. The wireless interface part 213 includes an interactive communication circuitry including at least one of elements such as a communication module, a communication chip, etc. corresponding to various kinds of wireless communication protocols. For example, the wireless interface part 213 includes a Wi-Fi communication chip for wireless communication with an access point based on Wi-Fi, a communication chip for wireless communication based on Bluetooth, Zigbee, Z-Wave, wireless HD, wireless gigabits, near field communication, etc., an infrared (IR) module for IR communication, a mobile communication chip for mobile communication with a mobile device, and the like.

The sink device 210 may include a display 214. The display 214 includes a display panel to display an image on a screen thereof. The display panel may have a light receiving structure such as a liquid crystal display (LCD) type, or a self-emissive structure such as an organic light emitting diode type. The display 214 may include an additional element according to the structure of the display panel. For example, if the display panel is of the LCD type, the display 214 includes an LCD panel, a backlight unit for providing light to the LCD panel, and a panel driving substrate for driving liquid crystal of the LCD panel.

The sink device 210 may include a user input receiver (e.g., including various user input receiving circuitry) 215. The user input receiver 215 includes circuitry related to various input interfaces for a user to manipulate to perform a user input. The user input receiver 215 may be variously configured according to the kind of the sink device 210, and, for example, may be a mechanical or electronic button of the sink device 210, a touch pad, a sensor, a camera, a touch screen installed in the display 214, a remote controller separated from a main body of the sink device 210, etc.

The sink device 210 may include a storage 216. The storage (e.g., a memory) 216 stores digitalized data. The storage 216 includes a nonvolatile storage in which data is retained regardless of whether power is supplied or not, and a volatile memory in which data to be processed by a processor 250 is loaded and is retained only when power is supplied. The storage may be a flash memory, a hard disc drive (HDD), a solid-state drive (SSD), a read only memory (ROM), etc., and the memory may be a buffer, a random-access memory (RAM), etc.

The sink device 210 may include a processor (e.g., including processing circuitry) 217. The processor 217 includes one or more hardware processors which are embodied as a central processing unit, a chipset, a buffer, a circuitry, etc. that are mounted on a printed circuit board. The processor 217 may also be embodied as a system on chip (SoC). If the sink device 210 is embodied as a display apparatus, the processor 217 includes modules corresponding to various processes such as a demultiplexer, a decoder, a scaler, an audio digital signal processor (DSP), an amplifier, etc. Here, a part or all of such modules may be embodied as the SoC. For example, the module related to image processing such as the demultiplexer, the decoder, the scaler, etc. may be embodied as an image processing SoC, and the audio DSP may be embodied as a chipset separated from the SoC.

Meanwhile, in the source device 220 may be provided elements such as an interface part (e.g., including interface circuitry) 221, a wired interface part 222, a wireless interface part 223, a display 224, a user input receiver (e.g., including user input receiving circuitry) 225, a storage (e.g., a memory) 225, a processor (e.g., including processing circuitry) 227, etc. The basic hardware configuration of the source device 220 is similar to the sink device 210 of the disclosure or to a conventional electronic apparatus. For example, to the above elements of the source device 220 may be applied the descriptions regarding the elements with the same term provided in the sink device 210, and thereby detailed descriptions regarding the elements of the source device 220 will be omitted.

When data of a content is received from the source device 220 through the wireless interface part 213, the processor 217 of the sink device 210 according to an embodiment processes the received data in a various manner and displays an image on the display 214. Because the processor 217 delays a time to display the image on the display 214 in consideration of wireless transmission environment, it is possible to prevent and/or reduce a phenomenon in which the image intermittently halts or is suddenly displayed fast in a period. Here, the processor 217 is capable of adjusting a delay time regarding the display time of the image related with a characteristic of the displayed image, and such operation will be described below.

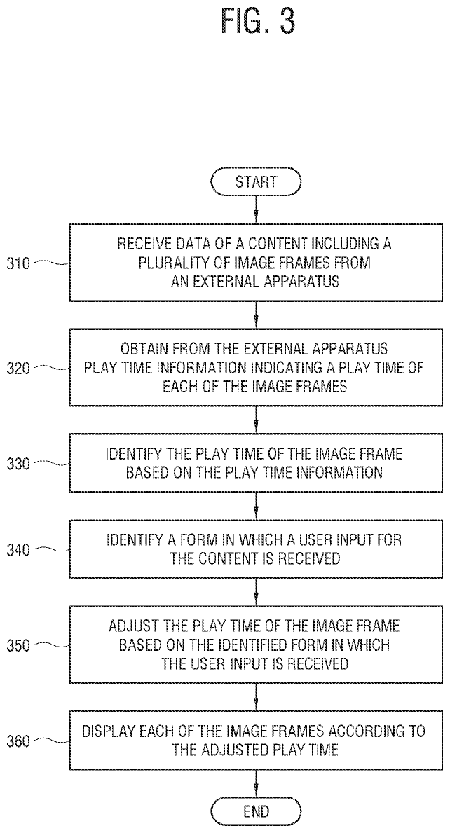

FIG. 3 is a flowchart illustrating an example operation of the sink device according to various embodiments.

As illustrated in FIG. 3, the following operations may be performed by the processor of the sink device.

At operation 310, the sink device receives data of a content including a plurality of image frames from an external apparatus.

At operation 320, the sink device obtains from the received data play time information indicating a play time of each of the image frames.

At operation 330, the sink device identifies the play time of the image frame based on the play time information.

At operation 340, the sink device identifies a form in which a user input for the content is received. The form in which the user input is received is a criterion that quantitatively indicates how positively or spontaneously a user responds to the content and may include, for example, a frequency or a number of times of the user input for the content.

At operation 350, the sink device adjusts the play time of the image frame based on the identified form in which the user input is received.

At operation 360, the sink device displays each of the image frames according to the adjusted play time.

Briefly, in displaying the image of the content received from the source device, the sink device adjusts the play time of the image in response to the identified form in which the user input for the content is received. For example, if the frequency that the user input for the content is received is relatively low, the sink device delays the play time of the image to be relatively late. Further, if the frequency that the user input for the content is received is relatively high, the sink device adjusts the play time of the image to be early relatively to a case in which the frequency that the user input is received is relatively low.

Accordingly, the sink device ensures convenience of a user who watches the image.

Meanwhile, the processor of the electronic apparatus may perform at least a part of data analysis, data process and result information generation based on at least one of machine learning, neural network, deep learning algorithms as a rule-based or artificial intelligence (AI) algorithm in order to adjust the play time of the image frame of the content based on the identified form in which the user input is received and display each of the image frames according to the adjusted play time.

For example, the processor of the electronic apparatus may function as a learner and a recognizer. The learner may perform a function of generating the learned neural network, and the recognizer may perform a function of recognizing (or inferring, predicting, estimating and identifying) the data based on the learned neural network. The learner may generate or update the neural network. The learner may obtain learning data to generate the neural network. For example, the learner may obtain the learning data from the storage unit of the electronic apparatus or from the outside. The learning data may be data used for learning the neural network, and the data subjected to the foregoing operations may be used as the learning data to teach the neural network.

Before teaching the neural network based on the learning data, the learner may perform a preprocessing operation with regard to the obtained learning data or select data to be used in learning among a plurality of pieces of the learning data. For example, the learner may process the learning data to have a preset format, apply filtering to the learning data, or process the learning data to be suitable for the learning by adding/removing noise to/from the learning data. The learner may use the preprocessed learning data for generating the neural network which is set to perform the operations.

The learned neural network may include a plurality of neural networks (or layers). The nodes of the plurality of neural networks have weights, and the plurality of neural networks may be connected to one another so that an output value of a certain neural network can be used as an input value of another neural network. As an example of the neural network, there are, for example, and without limitation, a convolutional neural network (CNN), a deep neural network (DNN), a recurrent neural network (RNN), a restricted Boltzmann machine (RBM), a deep belief network (DBN), a bidirectional recurrent deep neural network (BRDNN) and deep Q-networks.

Meanwhile, the recognizer may obtain target data to carry out the foregoing operations. The target data may be obtained from the storage unit of the electronic apparatus or from the outside. The target data may be data targeted to be recognized by the neural network. Before applying the target data to the learned neural network, the recognizer may perform a preprocessing operation with respect to the obtained target data, or select data to be used in recognition among a plurality of pieces of target data. For example, the recognizer may process the target data to have a preset format, apply filtering to the target data, or process the target data into data suitable for recognition by adding/removing noise. The recognizer may obtain an output value output from the neural network by applying the preprocessed target data to the neural network. Further, the recognizer may obtain a stochastic value or a reliability value together with the output value.

Below, an operation in which the sink device processes data of a content received from the source device will be described in greater detail.

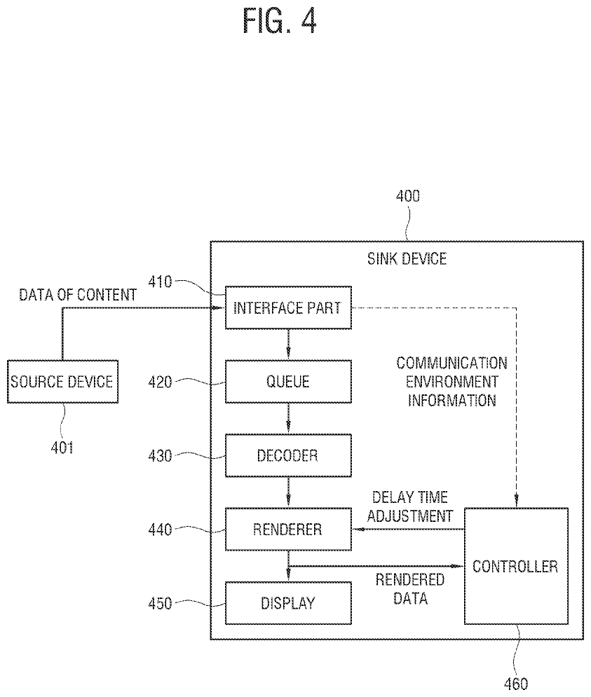

FIG. 4 is a block diagram illustrating various elements of the sink device for each role related to the processor of the sink device according to various embodiments.

As illustrated in FIG. 4, the sink device 400 receives data of a content from the source device 401 through the interface part 410. The data received through the interface part 410 is output to a display 450 via a queue 420, a decoder 430 and a renderer 440 sequentially. The queue 420, the decoder 430, the renderer 440 and the controller (e.g., including various control and/or processing circuitry) 460 are represented as independent elements in the disclosure. However, such elements in the sink device 400 are not limited to the independent embodiments, but at least a part of the elements may be installed in the processor of the sink device 400 or be integrated into a single processor practically, whereas they are distinguished for each function. Alternatively, at least a part of the elements may be embodied as software/program which is executed by the processor of the sink device 400.

The interface part 410 may include various interface circuitry and receives the data of the content from the source device 401 wirelessly. The data of the content includes image data that includes a plurality of image frames to which a play sequence is predefined and the play time information that indicates the play time of each of the image frames. The play time information includes, for example, time stamp information and, based on a clock or time, for example, in a millisecond unit, indicates which image frame is played and at what time the image frame is played from when the content starts to be played. For example, if the time stamp for an image frame is predefined as 20 milliseconds, the image frame is predefined to be played at a time that 20 milliseconds elapses from when the content starts to be played. Alternatively, if the time stamp for an image frame is predefined as 5,000 clocks, the image frame is predefined to be played at a time that 5,000 clocks have been counted from when the content starts to be played.

The queue 420 or a buffer is a place where data is stored temporally until the data is called or is read by the decoder 430. The queue 420 is provided so that the decoder 430 can read each image frame sequentially. If the queue 420 has a large storage capacity of data, this may refer, for example, to the sink device 400 being capable of setting a delay time further broadly regarding the play time of the image frame.

The decoder 430 decodes data which is read from the queue 420. As the data which is received at the interface part 410 may be encoded in various methods such as compression, packaging, etc. according to a predefined standard, the decoder 430 decodes the encoded data and restores to original raw data.

The renderer 440 may include various circuitry and/or executable program instructions and performs rendering on the decoded data to be displayed on the display 450. The renderer 440 outputs the rendered data to the display 450 to correspond to a predefined time. Here, the play time of the image frame may be adjusted by modifying an output time of the renderer 440 to be early or delayed by the controller 460.

The controller 460 may include various control and/or processing circuitry and adjusts the play time of the image frame to be displayed on the display 450 by interacting with the elements described above in a transmission flow of the data of the content via the interface part 410, the queue 420, the decoder 430, the renderer 440 and the display 450 in sequence. Because of the transmission flow of the data of the content, there necessarily occurs a time gap from when the data is received at the interface part 410 to when the image is displayed on the display 450. The renderer 440 delays the play time of the image by a predefined delay time based on the time gap. For this, the controller 460 may include a hardware chipset circuitry such as a microprocessor, etc.

Here, the controller 460 obtains from the renderer 440 the rendered data which is output to the display 450. The controller 460 controls the renderer 440 to increase or decrease the delay time according to an analysis result of the obtained data. That is, as the renderer 440 determines the play time of the image frame by adding a default value of the delay time to the time stamp of the image frame, the controller 460 adjusts the play time of the image frame by increasing or decreasing the default value of the delay time according to a condition. The controller 460 decreases the delay time if a frequency that a user input for the content is received is identified to be relatively high, and increases the delay time if the frequency that the user input for the content is received is identified to be relatively low. That is, the controller 460 makes the play time of the image to be relatively late as the content has a higher frequency that the user input is received.

The controller 460 may analyze the rendered data according to various methods. For example, the controller 460 may perform a scene analysis on the image frame of the rendered data to identify whether the user input is conducted at a corresponding scene or how many the user inputs are conducted. In this process, the scene analysis uses an AI model. The AI model may be stored in the sink device 400 or in a server which communicate with the sink device 400. In the latter case, the controller 460 may request for an AI model-based analysis by transmitting the rendered data to the server.

The controller 460 may identify a type of the content through the scene analysis of the image frame, other than identifying whether the user input is conducted. The type of the content is a parameter that is related with a form in which the user input is received, and, below, a relation between the type of the content and the form in which the user input is received will be described.

In displaying the image of the content which is received from the source device 401, the sink device 400 may selectively delay the play time of the image more or less in response to the form in which the user input for the content is received. The form in which the user input is received indicates how frequently a user responds to the content at a current time. If the user responds frequently, this may refer, for example, to the user inputs being conducted frequently. If the user does not respond frequently, this may refer, for example, to the user input being rarely conducted for the content. Here, the user input for the image which is displayed at the source device 401 may not be only conducted at the source device 401, but also be delivered to the source device 401 after the user input is conducted at the sink device 400.

For example, there is an image content such as a general video as a content for which the user input does not occur frequently. In this case, because a main behavior of the user is to watch an image of the content which is played, the user input for the content is expected to be merely a trivial and momentary behavior such as changing of volume or state of the image. The content is regarded as the frequency that the user input is received is low.

On the other hand, there are a game application, various user control applications, etc. as a content for which the user inputs occur frequently. In this case, the user who conducts the user input needs to check a change or feedback of the content thereto. The content is regarded as the frequency that the user input is received is high.

For example, the content may be classified into types which have the frequency that the user input is received is high or low. In this regard, the controller 460 may identify the form in which the user input is received according to the type of the content. Meanwhile, the embodiment has been described that the controller 460 identifies the form in which the user input for the content is received or the type of the content by analyzing the data which is output from the renderer 440. However, the method in which the controller 460 identifies the form in which the user input is received or the type of the content is not limited to only analyzing the data which is output from the renderer 440. Such will be described below.

Meanwhile, in adjusting the play time of the image, the controller 460 may further consider an additional parameter. For example, wireless transmission environment of the data may be measured based on a reception state in which the data of the content is received at the interface part 410. The reception state of the data may include a network jitter which is measured using a reception interval of the data, a noise degree, etc. The network jitter is a parameter which is inversely proportional to a reception degree at which the interface part 410 stably receives the data, and may refer, for example, to the transmission environment of the data being bad if the network jitter is large, whereas the transmission environment of the data is good if the network jitter is small.

The controller 460 may obtain from the interface part 410 communication environment information which indicates the wireless transmission environment of the data. The controller 460 identifies the wireless transmission environment of current data based on the communication environment information, and decreases the delay time if the wireless transmission environment is identified to be relatively good, while increasing the delay time if the wireless transmission environment is identified to be relatively bad.

In this way, the controller 460 is able to adjust the play time of the image by increasing or decreasing the delay time of the play time in response to the wireless transmission environment of the data of the content as well as the form in which the user input for the content is received. Alternatively, the controller 460 may adjust the play time of the image in response only to the form in which the user input for the content is received, without considering the wireless transmission environment of the data of the content.

Below, a method in which the sink device 400 adjusts the delay time regarding the play time of the image will be described in greater detail.

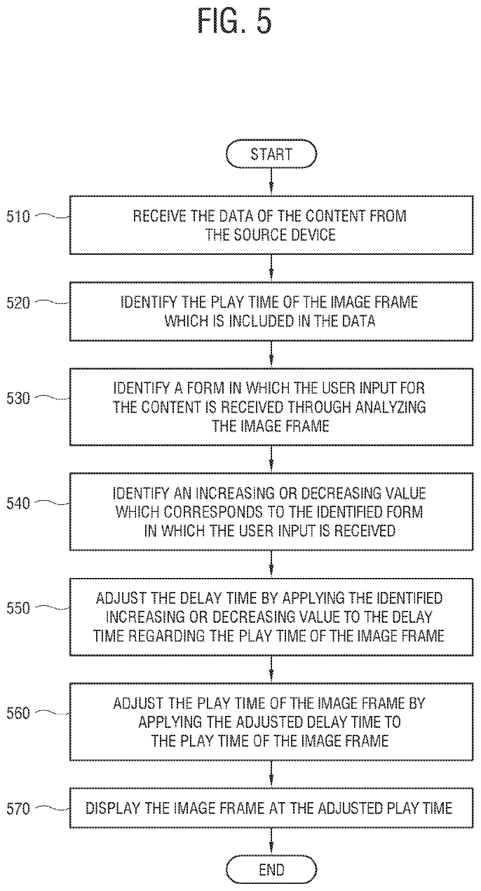

FIG. 5 is a flowchart illustrating an example process in which the sink device adjusts the delay time regarding the play time of the image according to various embodiments.

As illustrated in FIG. 5, the following operations may be performed by the processor of the sink device.

In operation 510, the sink device receives the data of the content from the source device.

In operation 520, the sink device identifies the play time of the image frame which is included in the received data. The play time of each image frame is predefined by, for example, the time stamp of each image frame included in the data.

In operation 530, the sink device identifies the form in which the user input for the content is received through analyzing the image frame. As described above, the form in which the user input is received may be the user input frequency for the content or the degree of the form may be identified based on the type of the content, etc.

In operation 540, the sink device identifies an increasing or decreasing value which corresponds to the identified form in which the user input is received. An increasing value for the delay time may be determined in response to the frequency that the user input is received being low, whereas a decreasing value for the delay time may be determined in response to the frequency that the user input is received being high.

In operation 550, the sink device adjusts the delay time by applying the identified increasing or decreasing value to the delay time regarding the play time of the image frame. That is, the delay time is increased in response to the frequency that the user input is received being low, whereas the delay time is decreased in response to the frequency that the user input is received being high.

In operation 560, the sink device adjusts the play time of the image frame by applying the adjusted delay time to the play time of the image frame.

In operation 570, the sink device displays an image so that the image frame is displayed at the adjusted play time.

Meanwhile, the embodiment in which the increasing value for the delay time is determined in response to the frequency that the user input is received being low, whereas the decreasing value for the delay time is determined in response to the frequency that the user input is received being high has been described above. However, a criterion value is not always classified into the increasing value and the decreasing value in response to the frequency that the user input is received being high or low. That is, a weighted value for the delay time, e.g., the increasing or decreasing value may be freely determined only if the play time where the frequency that the user input is received is low is more delayed than the play time where the frequency that the user input is received is high.

For example, the sink device may decrease the delay time in response to the frequency being high without adjusting the delay time in response to the frequency being low. Alternatively, the sink device may increase the delay time in response to the frequency being low without adjusting the delay time in response to the frequency being high.

It is supposed that the play time of the image frame is P, the delay time which is predefined as a default in the sink device is D, the weighted value for the delay time when the frequency that the user input for the content is received is relatively high is Dh, and the weighted value for the delay time when the frequency that the user input for the content is received is relatively low is Dw. The play time of the image when the frequency is high may be (P+D+Dh), whereas the play time of the image when the frequency is low may be (P+D+Dw). Although Dh and Dw may be a positive number or a negative number according to a design method, they are satisfied with a relation that Dh is smaller than Dw. That is, the play time of the image where the frequency that the user input is received is high is adjusted to be earlier than the play time of the image where the frequency that the user input is received is low.

Below, an example in which the user input is conducted for the content will be described in greater detail.

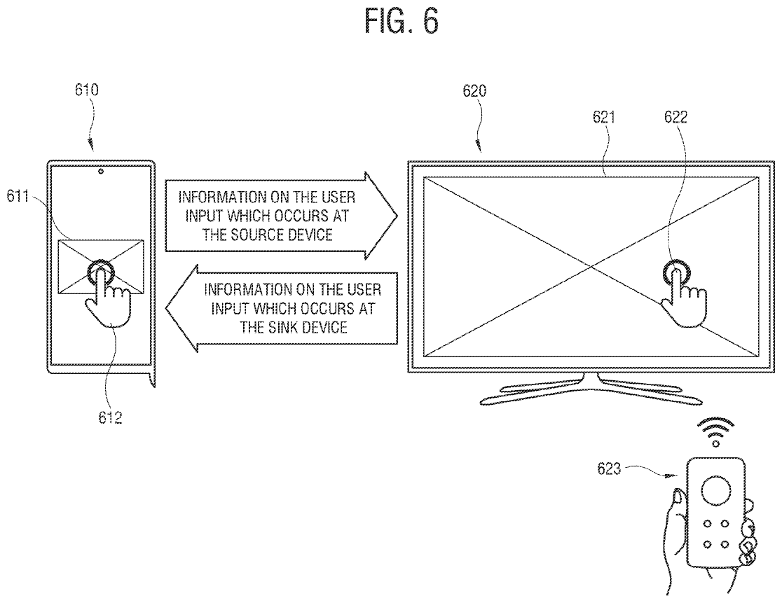

FIG. 6 is a diagram illustrating an example in which the user input is conducted at the source device or the sink device according to various embodiments.

As illustrated in FIG. 6, while the source device 610 is displaying a first image 611, the source device 610 transmits data of the first image 611 to the sink device 620 through the wireless communication according to a mirroring function. The sink device 620 processes the data which is received from the source device 610 and displays a second image 621 which is a mirroring image of the first image 611. In this way, while the source device 610 displays the first image 611 and sink device 620 displays the second image 621, a user input for the first image 611 or the second image 621 may be conducted at the source device 610 or the sink device 620 in various ways. Because of a characteristic that the mirroring image of the first image 611 is the second image 621, the user input for the first image 611 and the user input for the second image may be considered as a user input for a same content.

For example, a user input 612 for the first image 611 may be conducted at the source device 610. The user input 612 may include a touch input which is conducted in association with the first image 611 that is displayed on a touch screen where the source device 610 includes the touch screen. The user input 612 may be embodied in various ways such as a button input, an input through a remote controller, an input by a stylus pen, an input through an input device like a mouse or a keyboard, etc. The source device 610 identifies the user input 612, which has various types and is conducted to adjust a play state or a display state of the first image 611, as a user input which is to be conducted for the first image 611.

As the source device 610 adjusts a display state of the first image 611 according to the user input 612, data of the adjusted first image 611 is delivered to the sink device 620. Accordingly, a display state of the second image 621 is also adjusted to be synchronized with the first image 611. Here, the source device 610 may additionally transmit information on the user input 612 to the sink device 620. In this way, the sink device 620 identifies the form in which the user input for the first image 611 is received based on the information on the user input 612 which is received from the source device 610.

A user input 622, 623 for the second image 621 may be conducted at the sink device 620. The user input 622, 623 may be embodied in various ways such as a touch input 622 which is conducted in relation with the second image 621 which is displayed on a touch screen if the sink device 620 includes the touch screen, an input 623 through a remote controller of the sink device 620 or the like.

In this case, the sink device 620 transmits information on the user input 622, 623 to the source device 610. The information on the user input 622, 623 may be, for example, information on coordinates at which the touch input 622 occurs on the touch screen in case of the touch input 622 or information on input codes of the remote controller in case of the input 623 through the remote controller. The sink device 620 may identify the form in which the user input for the first image 611 or the second image 621 is received based on the user input 622, 623 which occurs itself at the sink device 620. Further, the sink device 620 transmits the information on the user input 622, 623 to the source device 610 to allow the source device 610 to adjust the display state of the first image 611 based on the information on the user input 622, 623.

In this way, the sink device 620 may identify the form in which the user input for the content of the first image 611 and the second image 621 is received based on various ways of the user inputs.

Meanwhile, the method in which the sink device identifies the form in which the user input for the content is received is not limited to performing of the scene analysis on the data of rendering the content. The sink device may obtain the information which is referred to in order to identify the form in which the user input for the content is received through various routes. Below, such an example embodiment will be described in greater detail.

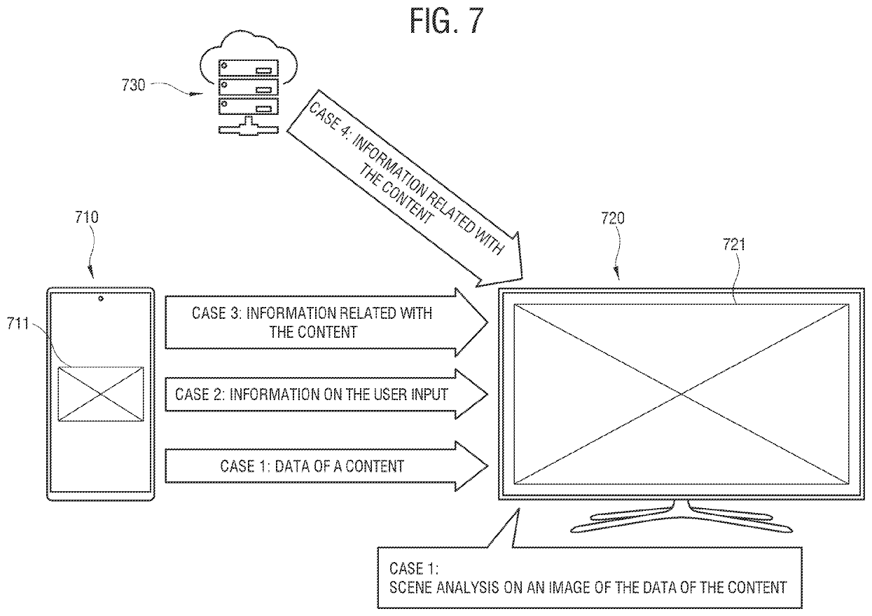

FIG. 7 is a diagram illustrating various example routes through which the sink device obtains the information which is referred to in order to identify the form in which the user input for the content is received according to various embodiments.

As illustrated in FIG. 7, the sink device 720 receives data of a content regarding a first image 711 from the source device 710 which displays the first image 711 and displays a second image 721 based on the data. In this state, the sink device 720 may identify the form in which the user input for the content is received according to information to be obtained through various routes or according to various methods described below.

In an example method, the sink device 720 receives from the source device 710 data which is buffered to display the first image 711. The sink device 720 processes the received data and displays the second image 721. The sink device 720 analyzes a scene of an image frame in the data which is rendered to display the second image 721 and identifies a characteristic of the scene. The characteristic of the scene of the image frame may be, for example, whether the user input is conducted for the image frame, a type of the content which is indicated by the image frame, or the like. The sink device 720 identifies the form in which the user input for the content is received based on the identified characteristic of the scene.

The sink device 720 may receive information on the user input from the source device 710. The user input may be conducted for the first image 711 which is displayed at the source device 710, where the source device 710 transmits information on the user input to the sink device 720. The information on the user input includes, for example, if a touch input is conducted, information on coordinates of the touch input, information on an object in the first image 711 for which the touch input is conducted, or the like. The sink device 720 may identify that the user input for the content has been conducted, if the received information on the user input is identified to be related with the second image 721.

The sink device 720 may receive information related with the content from the source device 710. The information related with the content includes, for example, information on a type or characteristic of the content. The information related with the content may be delivered as metadata which is included in the data of the content or be delivered as information which is separate from the data of the content through a channel which is separate from a channel of transmitting the data of the content. The sink device 720 may identify the form in which the user input for the content is received based on the information related with the content.

The sink device 720 may receive the information related with the content from a cloud server 730. In this case, the cloud server 730 may transmit the information related with the content according to a request from the source device 710 which output the data of the content or a request from the sink device 720 which receives the data of the content.

In this way, the sink device 720 may identify the form in which the user input for the content is received based on the information which is obtained according to various example methods.

Below, an example in which the sink device adjusts a display time of the image frame based on the identified form in which the user input is received will be described in greater detail.

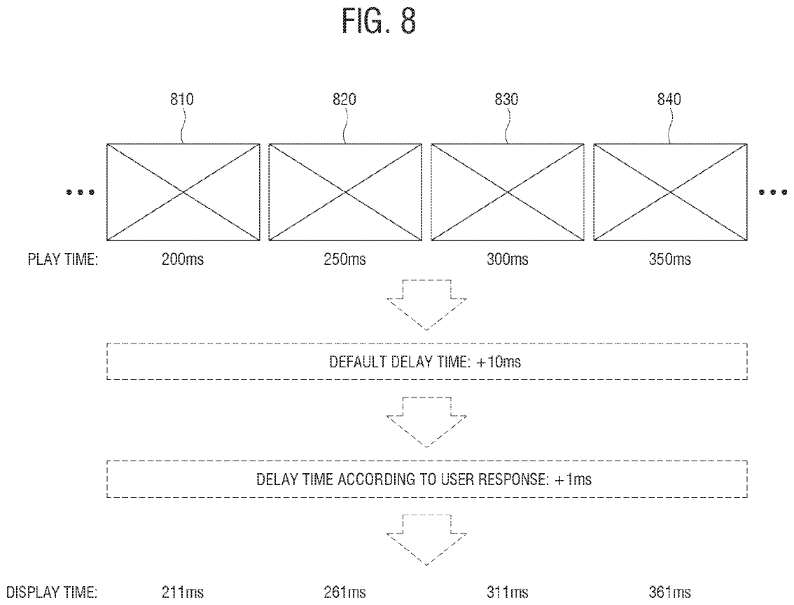

FIG. 8 is a diagram illustrating an example method in which the sink device adjusts the display time of each of a plurality of the image frames if a frequency that the user input for the content is received is relatively high according to various embodiments.

As illustrated in FIG. 8, the sink device receives data of a content which includes a plurality of image frames 810, 820, 830 and 840 from the source device. The received data includes time stamp information which predefines (e.g., specifies) the play time of the image frames 810, 820, 830 and 840. For example, the time stamp information may predefine 200 milliseconds for a first image frame 810, 250 milliseconds for a second image frame 820, 300 milliseconds for a third image frame 830 and 350 milliseconds for a fourth image frame 840. Such time information which is predefined by the time stamp information indicates a time which is predefined to play each of the image frames 810, 820, 830 and 840 from when the data of the content is received at the interface part or when the data of the content starts to play to display an image.

The sink device applies a predefined default delay time to each play time which is predefined by the time stamp information because of various causes such as a time which is taken to process the data in the sink device, a policy to play the content seamlessly and smoothly, etc. For example, the default delay time may be predefined as positive 10 milliseconds.

Further, the sink device identifies the predefined delay time in response to the form in which the user input for the content is received as described in the above embodiment. The delay time is not limited to a specific value, but the delay time where the frequency that the user input is received is relatively high may be small relatively to the delay time where the frequency that the user input is received is relatively low.

For example, supposed that the delay time where the frequency that the user input is received is relatively high is predefined to be positive 1 millisecond, the sink device additionally applies a value of the positive 1 millisecond to each play time to which the default delay time has been applied. Accordingly, the play time of each of the image frames 810, 820, 830 and 840 is adjusted by 211 milliseconds for the first image frame 810, 261 milliseconds for the second image frame 820, 311 milliseconds for the third image frame 830 and 361 milliseconds for the fourth image frame 840, respectively. The sink device finally identifies the adjusted play time as the play time of each of the image frames 810, 820, 830 and 840 and displays each of the image frames 810, 820, 830 and 840 at the identified play time.

Below, a case in which the frequency that the user input is received is relatively low will be described in greater detail.

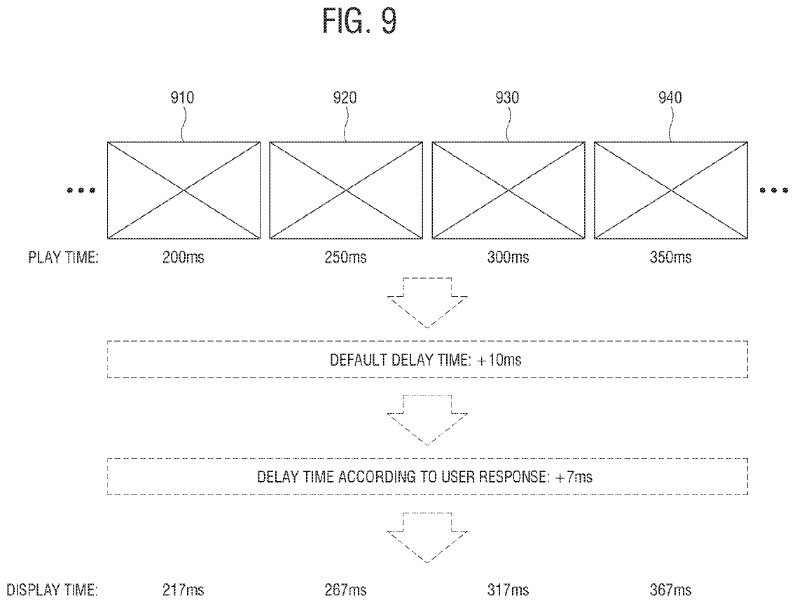

FIG. 9 is a diagram illustrating an example method in which the sink device adjusts the display time of each of a plurality of the image frames if a frequency that the user input for the content is received is relatively low according to various embodiments.

As illustrated in FIG. 9, the sink device receives data of a content which includes a plurality of image frames 910, 920, 930 and 940 from the source device. The received data includes the time stamp information which predefines the play time of the image frames 910, 920, 930 and 940. For example, the time stamp information may predefine 200 milliseconds for a first image frame 910, 250 milliseconds for a second image frame 920, 300 milliseconds for a third image frame 930 and 350 milliseconds for a fourth image frame 940.

The sink device applies the predefined default delay time to each play time which is predefined by the time stamp information because of various causes such as the time which is taken to process the data in the sink device, the policy to play the content seamlessly and smoothly, etc. For example, the default delay time may be predefined as positive 10 milliseconds.

Further, the sink device identifies the predefined delay time in response to the form in which the user input for the content is received as described in the above embodiment. For example, supposed that the delay time where the frequency that the user input is received is relatively low is predefined to be positive 7 milliseconds, the sink device additionally applies a value of the positive 7 milliseconds to each play time to which the default delay time has been applied. Accordingly, the play time of each of the image frames 910, 920, 930 and 940 is adjusted by 217 milliseconds for the first image frame 910, 267 milliseconds for the second image frame 920, 317 milliseconds for the third image frame 930 and 367 milliseconds for the fourth image frame 940, respectively. The sink device finally identifies the adjusted play time as the play time of each of the image frames 910, 920, 930 and 940 and displays each of the image frames 910, 920, 930 and 940 at the identified play time.

Compared to the above example of FIG. 8, the sink device of this embodiment differently identifies the delay time in response to the form in which the user input for the content is received. Because of such difference of the delay time, the display time of the image where the frequency that the user input is received is high is earlier than the display time of the image where the frequency that the user input is received is low. Accordingly, if the frequency that the user input is received is high, the sink device allows a response of the image of the content to the user input to be fast by displaying the image at an earlier time. On the other hand, if the frequency that the user input is received is low, the sink device allows the image of the content to be displayed smoothly without halting by displaying the image at a later time.

In this way, the sink device according to the disclosure is capable of enhancing convenience of a user by adjusting the display time of the image differently in response to the form in which the user input for the content is received.

The operations of the apparatus described in the foregoing embodiments may be performed by artificial intelligence provided in the apparatus. The artificial intelligence may be applied to various general systems by utilizing a machine learning algorithm. An artificial intelligence system refers to a computer system with intelligence of a human or being second to a human. In such a system, a machine, an apparatus or a system autonomously performs leaning and identifying and is improved in accuracy of recognition and identification based on accumulated experiences. The artificial intelligence includes elementary technologies to imitate functions of a human brain such as recognition, decision, etc. by utilizing machine learning technologies and algorithms of autonomously classifying and learning features of input data.

The elementary technologies may include, for example, and without limitation, at least one of language comprehension technology for recognizing a language and a text of a human, visual understanding technology for recognizing a thing like a human sense of vision, inference and prediction technology for identifying information and logically making inference and prediction, knowledge representation technology for processing experience information of a human into knowledge data, and motion control technology for controlling a vehicle's automatic driving or a robot's motion.

Here, linguistic comprehension may refer, for example, to technology of recognizing, applying and processing a human's language or text, and includes natural language processing, machine translation, conversation system, question and answer, voice recognition and synthesis, etc.

Inference and prediction may refer, for example, to technology of identifying information and logically making prediction, and includes knowledge- and probability-based inference, optimized prediction, preference-based plan, recommendation, etc.

Knowledge representation may refer, for example, to technology of automating a human's experience information into knowledge data, and includes knowledge building such as data creation and classification, knowledge management such as data utilization, etc.

The methods according to the foregoing example embodiments may be achieved in the form of a program instruction that can be implemented in various computers, and recorded in a computer readable medium. Such a computer readable medium may include a program instruction, a data file, a data structure or the like, or combination thereof. For example, the computer readable medium may be stored in a nonvolatile storage unit such as universal serial bus (USB) memory, regardless of whether it is deletable or rewritable, for example, a RAM, a ROM, a flash memory, a memory chip, an integrated circuit (IC) or the like memory, or an optically or magnetically recordable or machine (e.g., a computer)-readable storage unit medium, for example, a compact disk (CD), a digital versatile disk (DVD), a magnetic disk, a magnetic tape or the like. It will be appreciated that a memory, which can be included in a mobile terminal, is an example of the machine-readable storage unit medium suitable for storing a program having instructions for realizing the embodiments. The program instruction recorded in this storage unit medium may be specially designed and configured according to the embodiments, or may be publicly known and available to those skilled in the art of computer software. Further, the computer program instruction may be implemented by a computer program product.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic apparatus comprising:
a display;
at least one of interface part comprising interface circuitry; and
a processor configured to: receive data of a content including a plurality of image frames from an external apparatus through the interface part and process the image frames to display the plurality of image frames on the display based on the received data of the content,
wherein the processor is further configured to:
identify a play time of the image frame based on information obtained from the received data of the content,
identify a form in which an input for the content is received, and
adjust the identified play time of the image frame based on the identified form in which the input for the content is received.

2. The electronic apparatus according to claim 1, wherein the form in which the input is received comprises a frequency of the input for the content.

3. The electronic apparatus according to claim 1, wherein the processor is configured to adjust the play time based on a specified delay time.

4. The electronic apparatus according to claim 3, wherein the processor is configured to identify the delay time based on a communication environment in which the data of the content is transmitted from the external apparatus.

5. The electronic apparatus according to claim 3, wherein the processor is configured to identify the delay time based on a time taken from when the data of the content including the image frame is received at the interface part to when the image frame is displayed on the display.

6. The electronic apparatus according to claim 3, wherein the processor is configured to increase or decrease the delay time based on the form in which the input is received.

7. The electronic apparatus according to claim 6, wherein the processor is configured to identify the form in which the input is received based on a type of the content.

8. The electronic apparatus according to claim 6, wherein the processor is configured to decrease the delay time based on the input for the content being identified to be present at the external apparatus.

9. The electronic apparatus according to claim 8, wherein the processor is configured to identify whether the input is present based on a result of a scene analysis on the frame.

10. The electronic apparatus according to claim 8, wherein the processor is configured to identify whether the input is present based on a signal related with the input received from the external apparatus through the interface part.

11. The electronic apparatus according to claim 8, wherein the processor is configured to identify whether the input is present based on a signal related with the input received through the interface part from a server configured to communicate with the external apparatus.

12. The electronic apparatus according to claim 1, wherein the processor is configured to decode the data, and perform rendering of the data on which the decoding has been performed based on the adjusted play time.

13. A method of controlling an electronic apparatus, comprising:
receiving data of a content including a plurality of image frames from an external apparatus;
identifying a play time of the image frame based on information obtained from the received data of the content;
identifying a form in which an input for the content is received;
adjusting the identified play time of the image frame based on the identified form in which the input is received; and
displaying the image frame based on the adjusted play time.

14. The method according to claim 13, wherein the form in which the input is received comprises a frequency of the input for the content.

15. The method according to claim 13, further comprising: adjusting the play time based on a specified delay time.
